(19) United States
(12) Patent Application Publication
(10) Pub. No.: US 2023/0360571 A1
(43) Pub. Date: Nov. 9, 2023

(54) VISION CORRECTION OF SCREEN IMAGES

(71) Applicants: Nanyang Technological University, Singapore (SG); Nanoveu Pte Ltd, Singapore (SG)

(72) Inventors: Huy Cuong DANG, Singapore (SG); Chibiao CHEN, Singapore (SG); Philip Anthony SURMAN, Singapore (SG); Qijia CHENG, Singapore (SG)

(21) Appl. No.: 18/245,887

(22) PCT Filed: Sep. 16, 2021
(86) PCT No.: PCT/SG2021/050565

§ 371 Date: Mar. 17, 2023

(30) Foreign Application Priority Data
Sep. 18, 2020 (SG) 10202009203V

(51) Int. Cl. G09G 3/02; G06F 3/01

(52) U.S. Cl. CPC G09G 3/025; G06F 3/013; G09G 2354/00

(57) ABSTRACT

The present disclosure generally relates to a computerized method includes: receiving a set of pixel parameters of the display screen; receiving a set of lens parameters of a lens screen comprising an array of microlenses disposed in front of the display screen; receiving a set of eye parameters of an eye prescription; tracking the user's eye using an imaging device; constructing a projection matrix based on the pixel parameters, lens parameters, and eye parameters; generating an expected retina image that is expected to be focused on the retina of the user without the eye prescription; generating a target retina image for projection on the retina; iteratively adjusting the input screen image to determine an optimized screen image that minimizes an error between the corresponding target retina image and the expected retina image; and displaying the optimized screen image on the display screen.

### CROSS REFERENCE TO RELATED APPLICATION(S)

The present disclosure claims the benefit of Singapore Patent Application No. 10202009203V filed on 18 Sep. 2020, which is incorporated in its entirety by reference herein.

### TECHNICAL FIELD

The present disclosure generally relates to vision correction of screen images. More particularly, the present disclosure describes various embodiments of a computerized method and an electronic device for displaying screen images that are vision corrected for a user.

### BACKGROUND

Electronic devices such as mobile phones have display screens for displaying screen images. As the display screens are typically viewed at close distances, users with vision conditions such as hyperopia (far-sightedness) often require eyeglasses or corrective lenses to be able to see the screen images clearly. For users with vision conditions such as myopia (near-sightedness), they can view the display screens clearly without eyeglasses or corrective lenses, but often require them when they switch from looking at the display screens to seeing far distances. It is therefore troublesome for users to constantly wear and remove eyeglasses when they switch between viewing the display screens at close distances and seeing far distances.

Therefore, to address or alleviate at least one of the aforementioned problems and/or disadvantages, there is a need to improve displaying of vision corrected screen images for users.

### SUMMARY

According to a first aspect of the present disclosure, there is a computerized method for displaying vision corrected screen images on a display screen of an electronic device for a user viewing the display screen. The computerized method comprises:
receiving a set of pixel parameters of the display screen;
receiving a set of lens parameters of a lens screen of the electronic device, the lens screen comprising an array of microlenses disposed in front of the display screen;
receiving a set of eye parameters of an eye prescription for an eye of the user;
tracking the user's eye using an imaging device of the electronic device;
constructing a projection matrix based on the pixel parameters, lens parameters, and eye parameters, the construction comprising tracing light rays from each pixel of the display screen, through the microlenses that manipulate propagation of the light rays, to the retina of the user's eye;
generating an expected retina image that is expected to be focused on the retina of the user without the eye prescription;
generating a target retina image for projection on the retina, based on the projection matrix and an input screen image for displaying on the display screen;
iteratively adjusting the input screen image to determine an optimized screen image that minimizes an error between the corresponding target retina image and the expected retina image; and
displaying the optimized screen image on the display screen, wherein the optimized screen image is vision corrected for the user to view without the eye prescription.

According to a second aspect of the present disclosure, there is an electronic device for displaying vision corrected screen images. The electronic device comprises:
a display screen for displaying the vision corrected screen images for a user viewing the display screen;
a lens screen comprising an array of microlenses disposed in front of the display screen;
an imaging device for tracking an eye of the user; and
a processor configured for:
   receiving a set of pixel parameters of the display screen;
   receiving a set of lens parameters of the lens screen;
   receiving a set of eye parameters of an eye prescription for an eye of the user;
   tracking the user's eye using the imaging device;
   constructing a projection matrix based on the pixel parameters, lens parameters, and eye parameters, the construction comprising tracing light rays from each pixel of the display screen, through the microlenses that manipulate propagation of the light rays, to a retina of the user's eye;
   generating an expected retina image that is expected to be focused on the retina of the user without the eye prescription;
   generating a target retina image for projection on the retina, based on the projection matrix and an input screen image for displaying on the display screen;
   iteratively adjusting the input screen image to determine an optimized screen image that minimizes an error between the corresponding target retina image and the expected retina image; and
   displaying the optimized screen image on the display screen, wherein the optimized screen image is vision corrected for the user to view without the eye prescription.

A computerized method and an electronic device for displaying vision corrected screen images according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a display screen and a lens screen.

FIGS. 2A and 2B are illustrations of light propagation from the display screen through the lens screen to an eye.

FIG. 3 is a flowchart illustration of a computerized method for displaying vision corrected screen images on the display screen.

FIG. 4 is an illustration of an experiment on the computerized method for displaying vision corrected screen images on the display screen.

FIGS. 5A and 5B are illustrations of light propagation from the display screen to a microlens at different gap distances between them.

FIGS. 6A and 6B are illustrations of light propagation for different microlens designs.

### DETAILED DESCRIPTION

For purposes of brevity and clarity, descriptions of embodiments of the present disclosure are directed to a computerized method and an electronic device for displaying vision corrected screen images, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range. The terms “first”, “second”, etc. are used merely as labels or identifiers and are not intended to impose numerical requirements on their associated terms.

In representative or exemplary embodiments of the present disclosure, there is an electronic device for displaying screen images including vision corrected screen images for a user. The electronic device may be a mobile device, mobile phone, smartphone, personal digital assistant (PDA), e-reader, tablet, phablet, laptop, computer, other communication device, or the like. For example, the electronic device may be incorporated in a cash register or a car dashboard.

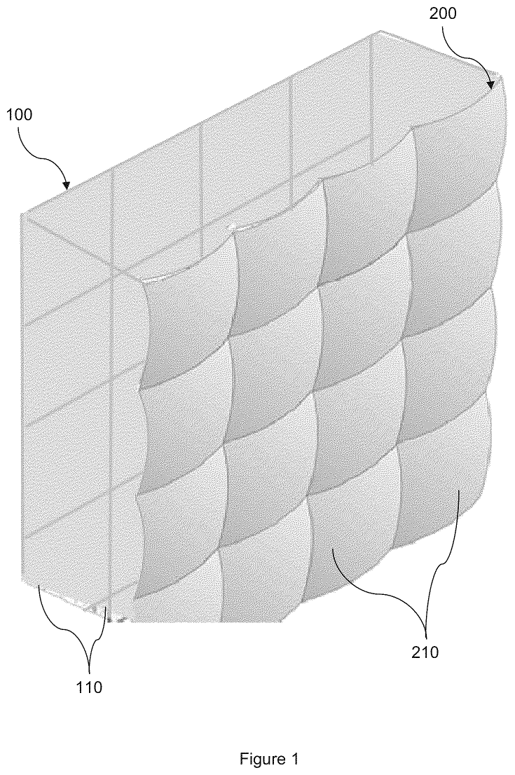

As shown in FIG. 1, the electronic device includes a display screen 100 or display panel substrate for displaying the vision corrected screen images for the user. The display screen 100 may be referred to as a display layer, panel, or substrate. The electronic device further includes a lens screen 200 including an array of microlenses 210 disposed in front of the display screen 100. The lens screen 200 may be referred to as a microlens layer, panel, or substrate. The lens screen 200 may be of any size catered to an area or the whole of the display screen 100, and the microlenses 210 may be arranged in a square array. For example, the lens screen 200 may be in the form of a screen protector applied on the display screen 100. The electronic device further includes an imaging device for tracking an eye 300 of the user viewing the display screen 100. The imaging device is configured with eye tracking sensor technology to determine where the user is looking. For example, the imaging device emits infrared light that is reflected from the user's eye 300 and detected by the imaging device for calculations to locate and track the eye 300. The electronic device further includes a processor configured for controlling the display screen 100 and imaging device.

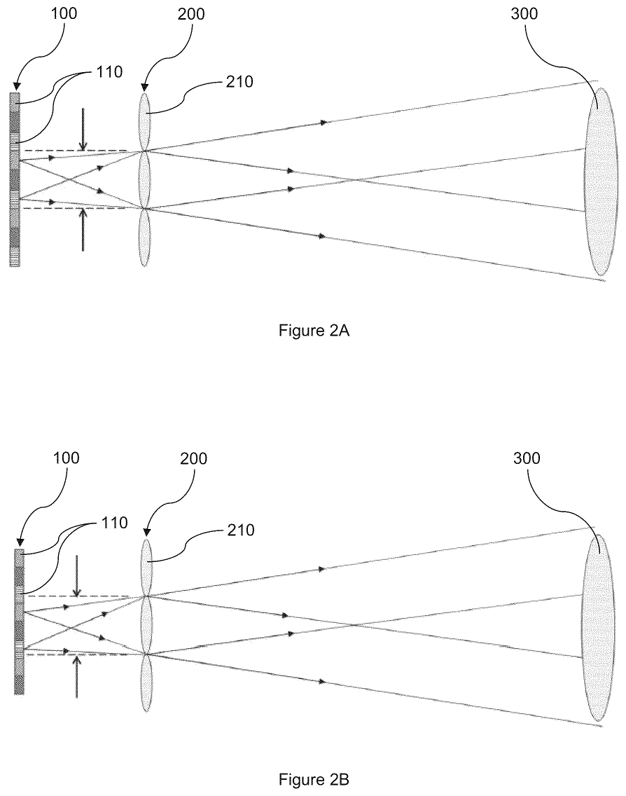

The display screen 100 has an array of pixels 110 and each pixel 110 is controlled by the processor to create screen images on the display screen 100. Each pixel 110 may be divided into a plurality of sub-regions or sub-pixels to enhance the resolution of the display screen 100. Each pixel 110 acts as a light source and light rays from each pixel 110 are emitted at large angles. The user should focus his/her eyes 300 on the display screen 100 in order to form clear retina images on the retina of the eyes 300. As shown in FIGS. 2A and 2B, by positioning the lens screen 200 in front of the display screen 100, both the intensity and the directionality of the emitted light rays from the pixels 110 can be controlled. Specifically, the pixels 110 are at the focal plane of the lens screen 200 and the emitted light rays from the pixels 110 can be directed into parallel light rays to the eyes 300.

The position of a pixel 110 with respect to a microlens 210 determines the direction of the light ray from the pixel 110. The lens pitch between the microlenses 210 and dimensions (including size and/or shape) of the microlenses 210 determine the number of light rays that can be controlled in each microlens 210. For example, if each microlens 210 covers an array of 5×5 pixels 110, then the microlens 210 controls the light rays from all 25 pixels 110. In one embodiment as shown in FIG. 2A, the microlenses 210 are arranged such that the lens pitch is matched to the pitch of the pixels 110. For example, the lens pitch is equivalent to 3 pixel widths. In another embodiment as shown in FIG. 2B, the microlenses 210 have an arbitrary lens pitch relationship to that of the pixels 110.

The arrangement of the microlenses 210 of the lens screen 200 can thus vary with respect to the display screen 100 as shown in FIGS. 2A and 2B. Particularly, it is not necessary for each microlens 210 to be aligned to an integer number of pixels 110, such as shown in FIG. 1. If the lens screen 200 must be aligned to the display screen 100 in this manner, a unique lens screen 200 must be made for every display screen 100 with a different pixel per inch (PPI) value. There might also be problems with achieving exact alignment because of manufacturing dimensional variations. Without requiring such exact alignment between the microlenses 210 and pixels 110, new electronic devices can be produced quicker, and production costs are reduced as expensive new tooling is not required every time.

Therefore, with the display screen 100 and lens screen 200 in place, well-defined directions of the light rays from each pixel 110 can be determined. The processor of the electronic device is configured for performing a computerized or computer-implemented method 400 for displaying vision corrected screen images on the display screen 100 for the user viewing the display screen 100.

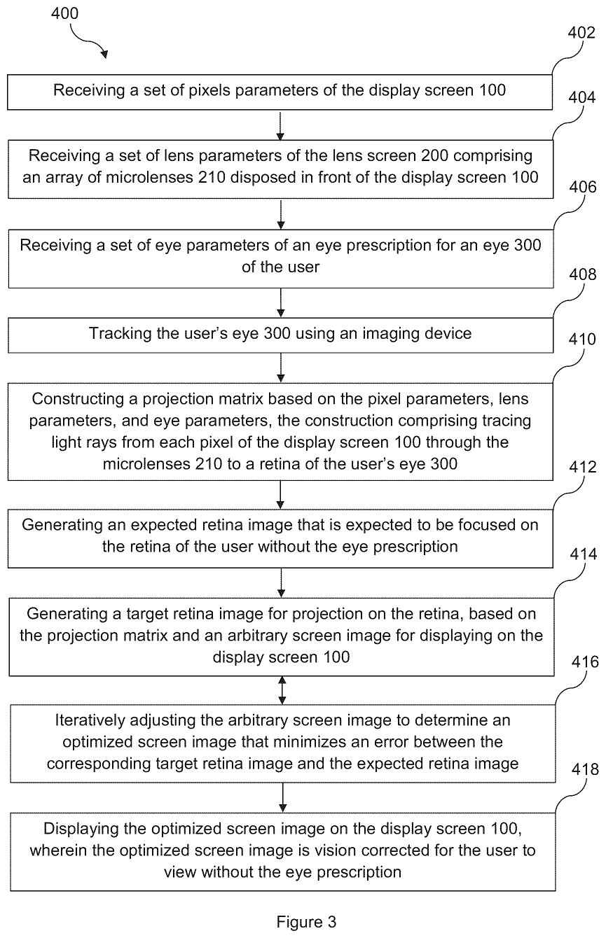

As shown in FIG. 3, the method 400 includes a step 402 of receiving a set of pixel parameters of the display screen 100. The pixel parameters can be obtained from the manufacturer of the display screen 100 or the electronic device, and may include at least one of pixel pitch between the pixels 110, dimensions of the pixels 110, arrangement of sub-regions, and dimensions of the sub-regions. The method 400 includes a step 404 of receiving a set of lens parameters of the lens screen 200. The lens parameters can be obtained from the manufacturer of the lens screen 200, and may include at least one of lens pitch between the microlenses 210, dimensions of the microlenses 210, and imaging properties of the microlenses 210. The imaging properties generally refer to the manipulation of light passing through the microlenses 210 and are dependent on the design and construction of the microlenses 210.

The method 400 includes a step 406 of receiving a set of eye parameters of an eye prescription for an eye 300 of the user. The eye parameters can be obtained from the user's ophthalmologist or optometrist, and may include at least one of degree of myopia, degree of hyperopia, degree of presbyopia, and degree of astigmatism, and angle of astigmatism. The method 400 includes a step 408 of tracking the user's eye 300 using the imaging device.

With the pixel parameters, lens parameters, eye parameters, and eye tracking, the processor can trace the light rays from the pixels 110 to the retina of the eye 300 whereon the light rays are resolved to form a retina image for the user. A mathematical projection matrix is developed to transform the screen images on the display screen to retina images on the retina. Specifically, the projection matrix builds a map of a four-dimensional (4D) light field from the screen images and transforms the 4D light field into a 2D retina image. The 4D light field may be parameterized by two spatial coordinates and two angles.

The method 400 includes a step 410 of constructing the projection matrix based on the pixel parameters, lens parameters, and eye parameters. The construction of the projection matrix includes tracing light rays from each pixel 110 of the display screen 100, through the microlenses 210 that manipulate propagation of the light rays, to the retina of the user's eye 300. More specifically, the microlenses 210 manipulate propagation of the light rays, such as by changing their direction of propagation, as they pass through the microlenses 210 to the user's eye 300. The projection matrix P is represented in Equation 1, wherein S represents a screen image and R_{S} represents a retina image generated from the screen image S. The inverse of the projection matrix P is represented as P⁻¹ in Equation 2.

R_{S}=P×S [Equation 1]

S=P⁻¹×R_{S} [Equation 2]

Ray tracing is a method for calculating the path of light waves by propagating a discrete number of light rays using mathematics. Ray tracing is employed to construct the projection matrix by considering each pixel 110 on the display screen 100 as a light source and tracing the light rays from the pixel 110 through the microlenses 210, which manipulate propagation of the light rays passing therethrough, and then through the eye 300 until the light rays finally reach the retina. The ray tracing is repeated for every pixel 110 of the display screen 100. However, some of the light rays may not or may partially pass through the eye 300. The construction of the projection matrix may include numerical interpolation of the light rays that partially pass through the eye 300.

In some embodiments, each pixel is divided into a plurality of sub-regions, such as at 4 corners of the pixel 110. The construction of the projection matrix includes tracing light rays from each sub-region through the microlenses 210 to the retina. The ray tracing is repeated for every sub-region of each pixel 110 and then for every pixel 110 of the display screen 100. Ray tracing from the sub-regions can construct the projection matrix with a very high level of detail because each pixel 110 is assumed as multiple tiny light sources (sub-regions) rather than a single light source (central point of the pixel 110). This will make the projection of screen images to retina images by the projection matrix closer to reality.

In the ray tracing from the pixels 110 to the microlenses 210 and retina, light rays are traced from each and every pixel 110/sub-region to each and every microlens 210. For example, a light ray from the topmost pixel 110 can reach the bottommost microlens 210, but the light ray may not reach the retina after passing through the microlens 210. For any one microlens 210, the light rays from some pixels 110 passing through the microlens 210 would not reach the retina. In other words, there is a group of pixels 110 whereby the light rays from these pixels 110 can pass through the microlens 210 and reach the retina. Hence, each microlens 210 can be associated with a respective group of pixels 110.

The method 400 includes a step 412 of generating an expected retina image that is expected to be focused on the retina of the user without the eye prescription. Specifically, the expected retina image (denoted as R_{E}) is directly generated by the processor and corresponds to a screen image on the display screen 100. The expected retina image is a scaled copy of the screen image and is the image that would be formed on the retina of a user with normal vision when the display screen 100 is displaying the screen image. When the user views the screen image without the eye prescription, i.e. without eyeglasses or corrective lenses, the light from the display screen 100 focuses on the retina and the expected retina image R_{E} formed on the retina is clear and sharp enough for the user. However, because the user requires the eye prescription, looking at the screen image, which is a normal screen image that is not vision corrected for the user, without the eye prescription would not result in a focused retina image.

A corrected screen image, which would result in a focused retina image that is clear and sharp for the user, can be generated using Equation 2, i.e. with the inverse projection matrix P⁻¹. However, because the projection by the projection matrix P is carried out from a 4D space to a 2D space, a direct calculation of the inverse projection matrix P⁻¹ would be mathematically intractable. To address this problem, the method 400 includes a step 414 of generating a target retina image for projection on the retina, based on the projection matrix and an input screen image for displaying on the display screen 100. Specifically, the input screen image S, such as one corresponding to the expected retina image R_{E}, is generated and the target retina image R_{S} is generated based on the input screen image S and the projection matrix P according to Equation 1.

As the input screen image S is not vision corrected for the user, the corresponding target retina image R_{S} would not be focused on the retina. This results in an error or discrepancy between the target retina image R_{S} and the expected retina image R_{E}. This error is represented as a cost function C in Equation 3. Since R_{S} is defined in Equation 2, the cost function C can be alternatively defined in Equation 4.

C=∥R_{S}−R_{E}∥ [Equation 3]

C=∥(P×S)−R_{E}∥ [Equation 4]

The method 400 includes a step 416 of iteratively adjusting the input screen image S to determine an optimized screen image that minimizes an error between the corresponding target retina image R_{S} and the expected retina image R_{E}. In this iterative process, the method 400 executes multiple iterations of adjusting the screen image S, calculating the corresponding target retina image R_{S}, and comparing the target retina image R_{S} with the expected retina image R_{E}, until the error or cost function C is minimized. The initial input screen image S is arbitrarily determined or guessed to initiate the iterative process which then searches for and approximates the optimized screen image by minimizing the cost function.

The method 400 includes a step 418 of displaying the optimized screen image on the display screen 100, wherein the optimized screen image is vision corrected for the user to view without the eye prescription. The optimized screen image corresponds to the target retina image that is focused on the user's retina without the eye prescription, because the target retina image is closest to the expected retina image. The user can thus view the optimized screen image clearly on the display screen 100 without the eye prescription.

Preferably, the projection matrix is constructed the first time the user uses the electronic device because the projection matrix would be specific to the user's eye parameters and vision conditions. The projection matrix can be used to render optimized screen images for the same user every time the user uses the electronic device. The projection matrix is stored on the electronic device for lifetime use by the user. Additionally, the projection matrix can tolerate some movements of the user or positional variations of the user's eye 300 being tracked by the imaging device without significantly affecting the vision corrected screen images. For example, movements of the user along the left-right/top-down directions, as viewed from the perspective of the user facing the electronic device, would not compromise the vision correction because the distance from the user's eye 300 to the display screen 100 is unchanged.

In some embodiments, the method 400 includes a step of modifying the projection matrix based on positional variations of the user's eye 300. This modification can be performed to refine the projection matrix to account for certain positional variations and to improve the quality of the vision corrected screen images for the user. For example, movements of the user along the forward-backward direction relative to the electronic device would change the distance between the user's eye 300 and the display screen 100. This change in distance could affect the rendering of vision corrected screen images because the projection matrix was constructed based on the ray tracing along a certain distance from the display screen 100 to the user's eye 300. However, as the user's movements are generally predictable and the magnitude of the user's movements is small relative to the distance, and that the user's eye parameters and vision conditions are constant, only minor modifications to the projection matrix would be required. This modifying of the projection matrix would not require significant computational resources and can be performed in real-time.

In some embodiments, the display screen 100 is configured for displaying high-definition resolution, such as FHD or 4K UHD resolution. For the same size, the display screen 100 has a higher PPI value which means that there are more pixels 110 and light rays to resolve by the projection matrix. The iterative process to approximate and determine the optimized screen image may be computationally intensive for the processor and the method 400 may not be able to run in live or real-time mode with high-definition resolution.

The projection matrix is normally a sparse matrix with many zero elements from light rays that do not reach the eye 300. There are also many repeated elements from coincident light rays that are redundant and can be excluded from the projection matrix. Thus, the projection matrix can be simplified to improve the efficiency of the iterative process. Specifically, in the method 400, the construction of the projection matrix may include calculating approximate solutions to Maxwell's equations for light propagation to simplify the projection matrix.

The simplified projection matrix has reduced complexity and improves the iterative process so that it can process each iteration more quickly. With a faster and more efficient iterative process, computational time and resource requirements are reduced, and the method 400 can be used for vision corrections in normally computationally intensive situations. For example, the method 400 with the projection matrix simplified using the approximate solutions to Maxwell's equations can be used to vision correct animated images or videos, including live video performances whereby screen images are displayed at high frame rates.

The relationship between the target retina images and screen images in Equation 1 was studied with solutions of electromagnetic wave propagation based on Maxwell's equations for incoherent light wave propagation from the display screen 100 through the microlenses 210 to the eye 300. The projection matrix is thus constructed based on a combination of the mathematical model and physical solutions to Maxwell's equations. The physical solutions, which are derived from optical behaviours of the electromagnetic waves, are used to exclude redundant and/or repeated light rays, thereby reducing the rank of the projection matrix.

With a simplified projection matrix, the range to search for and approximate the optimized screen image is narrowed, hence reducing the computational load on the mathematical model. The computational efficiency of the iterative process is enhanced as a result and the optimized screen image can be more quickly determined by the iterative process. For example, the time taken to determine the optimized screen image can be reduced to less than 10 ms per image, which is equivalent to more than 100 frames per second (FPS). At this efficiency, vision corrected screen images can be rendered in real-time applications, such as video conferences (which can have a frame rate of 60 FPS) and computer games (which can have a frame rate of 90 FPS).

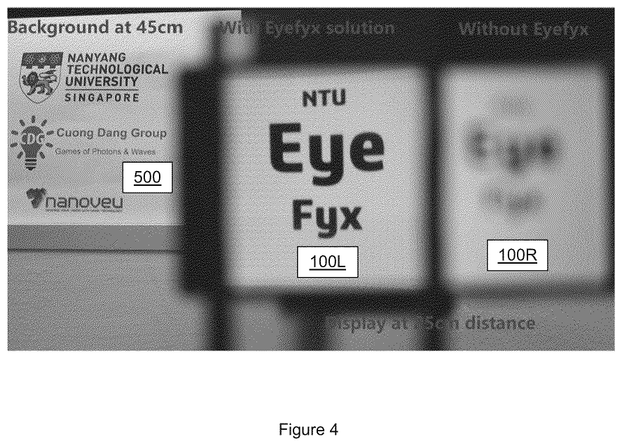

An experiment was performed to test the method 400 for vision correction of screen images on the display screen 100. The display screen 100 of a generic smartphone was placed 25 cm (simulating the normal reading distance) in front of a digital mirrorless camera (simulating the eye 300) to mimic the perceived result of the human visual system. The camera was set to focus on a background 500 that was placed 45 cm behind the display screen 100. This mimics an eye vision condition that corresponds to a correction value of 1.8 diopters (180 degrees). The left part 100L of the display screen 100 was covered by the lens screen 200 (having the array of microlenses 210 with 1 mm lens pitch) to test the vision correction method 400. The right part 100R of the display screen 100 did not have the lens screen 200 and was used for comparison. As shown in FIG. 4, the results of the experiment show that the camera can view screen images on the left part 100L that were vision corrected and clear, but not on the right part 100R where the screen images appeared blurry.

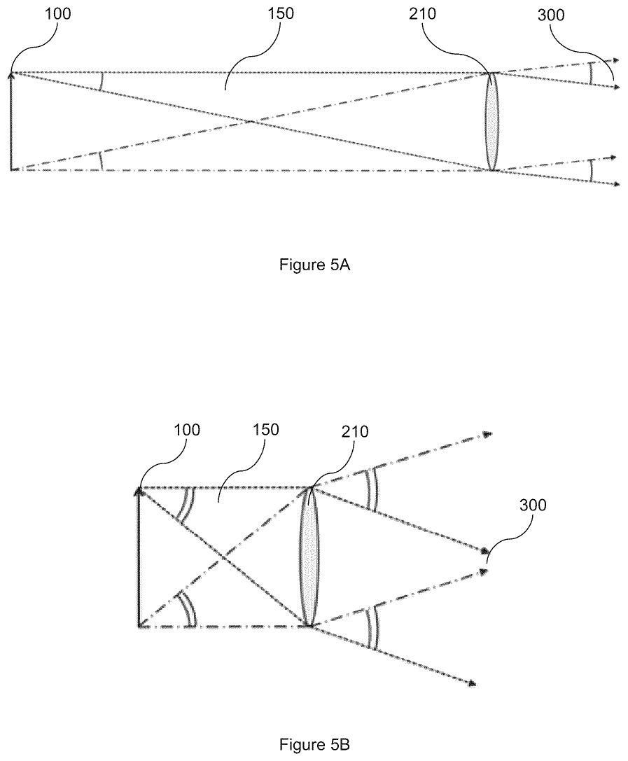

As described above, the projection matrix is constructed based on the pixel parameters, lens parameters, and eye parameters. The image quality of the retina images improves with more angular resolution, which is defined as the number of pixels 110 under each microlens 210. The angular resolution can be increased with a higher screen resolution, i.e. a higher PPI value, such that the pixels 110 are smaller and there are more pixels 110 under the same microlens 210. As shown in FIG. 5A, the lens screen 200 is disposed at a standard gap distance 150 from the display screen and light rays from the pixels 110 are emitted at certain incident angles to the microlenses 210.

The angular resolution can also be increased with larger microlenses 210 and a larger lens pitch so that each larger microlens 210 can cover more pixels 110, given the same standard gap distance 150. However, this would result in the pixels 110 emitting light rays at larger incident angles to the microlenses 210. Some or many of the light rays would not reach the microlenses 210 and consequently would not reach the eye 300, hence diminishing the effectiveness of the projection matrix. The gap distance 150 can be increased so that the light rays can reach the larger microlenses 210 at the smaller incident angles. However, the larger gap distance 150 would reduce or lose any touchscreen capability or sensitivity of the display screen 100. The lens screen 200 can be positioned closer to the display screen 100 to maintain the touchscreen sensitivity, such as shown in FIG. 5B, but the incident angles would be larger and some or many light rays would not reach the microlenses 210 and eye 300.

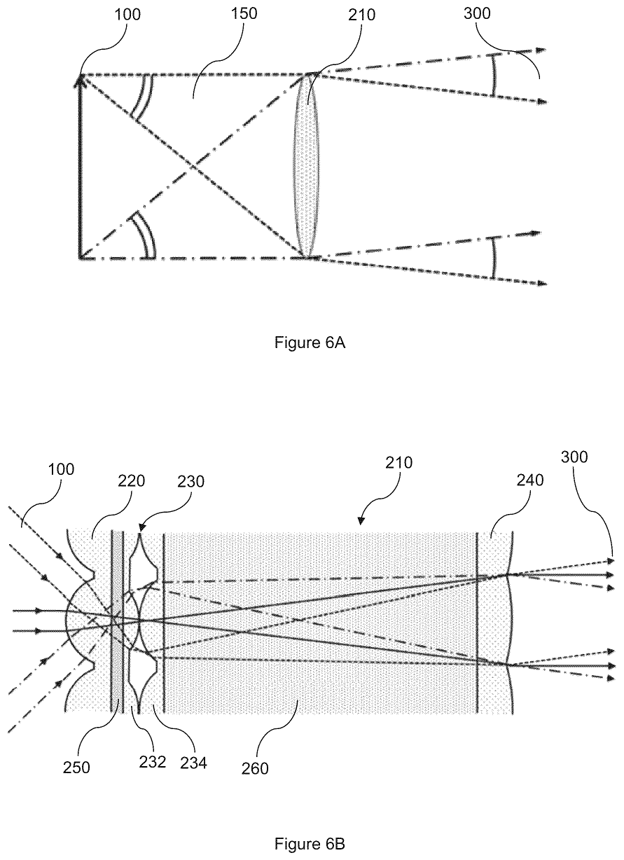

Preferably, as shown in FIG. 6(a), the lens screen 200 is positioned close to the display screen 100 with a small gap distance 150 to maintain the touchscreen sensitivity, the microlenses 210 are large and have a large lens pitch, and the incident angles are small such that the light rays from the pixels 110 can reach the microlenses 210. For example, the lens pitch is at least 1 mm, which is equivalent to about 30-50 times of the pixel pitch, and the gap distance 150 is less than 5 mm to maintain the touchscreen sensitivity.

However, at this configuration and focal length corresponding to the gap distance 150, the incident angles of the light rays from the pixels 110 to the microlenses 210 are too large at about 30° to 60°.

The incident angles should be reduced to less than 5°, preferably 1° to 3°, so that most if not all of the light rays from the pixels 110 can reach the microlenses 210. A single-element microlens 210 may not be capable to achieve this reduction of incident angles, but a multi-element microlens 210 may be able to. For example, the multi-element microlens 210 has a Gabor superlens structure wherein angular compression can be achieved. A Gabor superlens is one that comprises two or more lens elements with different pitches and has different imaging properties compared to a conventional lens. The microlens 210 or Gabor superlens can provides an angular compression where the angle of the light rays exiting the microlens 210 at any given point is smaller than the light rays entering that point. Comparatively, in a conventional lens, this angle remains substantially unchanged.

There are various designs of microlenses 210 with multiple lens elements to meet these requirements. In one embodiment as shown in FIG. 6(b), each microlens 210 includes a relay lens 220, a field lens 230, and an objective lens 240. A first substrate 250 is disposed between the relay lens 220 and field lens 230, and a second substrate 260 is disposed between the field lens 230 and objective lens 240. The relay lens 220 is arranged for receiving light from the display screen 100. The relay lens 220 is like a fisheye lens that is able to receive incident light rays at large angles. The field lens 230 is arranged for collimating the light from the relay lens 220 to the objective lens 240. The field lens 230 may include a first lens element 232 and a second lens element 234 cooperative to collimate the light toward the objective lens 240. The objective lens 240 is arranged for receiving the collimated light from the field lens 230 and directing the collimated light to the user's eye 300. Specifically, the objective lens 240 is a longer lens element that is able to direct the light rays to the eye 300 at smaller outgoing angles compared to the incident angles. Therefore, despite the small gap distance 150 of less than 5 mm, the multi-element microlenses 210 are able to capture the light rays from the pixels 110 at large incident angles and transform them into collimated light rays at smaller outgoing angles to the eye 300 to ensure that the light lands on the retina.

The electronic device and method 400 are thus able to display screen images that are optimized and vision corrected for the user according to his/her vision condition, so that the user can view the screen images clearly without his/her eye prescription. The user inputs the eye parameters and the projection matrix is constructed to render the optimized screen images for the user to enjoy without wearing eyeglasses or corrective lenses. The projection matrix may be stored on the electronic device for lifetime use by the user.

As mentioned above, it is not necessary for each microlens 210 to be aligned to an integer number of pixels 110. The array of microlenses 210 can be in any arrangement and the lens pitch is independent from the pixel pitch. The precise dimensions and positions of the microlenses 210 are not critical as these lens parameters can be compensated for by the method 400. Any lens screen 200 can thus be used for the display screen 100 without customizing it based on the user's eye prescription. This enables a single lens screen 200 to be used for various display screens 100, i.e. one lens for all. The projection matrix is also less periodic than other projection matrices for regular microlens arrays which are made specifically to match the lens pitch to the pixel pitch. Given any lens screen 200 for the display screen 100, the processor can perform the method 400 to resolve the alignment of the microlenses 210 with the pixels 110 and render vision corrected screen images.

The method 400 does not cause any trade-off between the correction quality and the perceived resolution of the screen images, which is determined by the size of the microlenses 210. This is because the microlenses 210 are used to direct light rays to the retina, and the microlenses 210 themselves are not resolved on the retina as they are at the distance at which the vision-impaired eye 300 cannot focus. The optimized screen images are rendered accordingly to correct for visual aberrations of the user. The visual aberrations include low order aberrations such as myopia, hyperopia, and astigmatism.

The visual aberrations may also include high order aberrations such as spherical aberration, coma, and trefoil.

Many people suffer from vision conditions or visual aberrations such as age-related loss of visual accommodation (presbyopia), far-sightedness (hyperopia), and astigmatism. Particularly, presbyopia is one of the most common causes for blurred vision and everyone is likely to get presbyopia as they get older as it is a normal part of aging. Use of the electronic device and method 400 can help vision-impaired people to view the display screen 100 clearly without their eye prescription, as elaborated in some exemplary applications below.

Many people, especially those suffering from hyperopia, tend not to wear eyeglasses when reading on their mobile devices or smartphones, due to reasons of vanity or discomfort that might be caused by incorrect eye prescriptions and/or problems with their eyeglasses. To compensate for blurred vision, these people can use various software options on their mobile devices, such as to expand text to make it easier to read. But this can strain the eye muscles as the eye lenses are at the limit of their accommodation, causing similar eyestrain experienced with accommodation/convergence conflict conditions in 3D displays. The method 400 advantageously addresses these problems by vision correcting the screen images on the display screen 100 and enabling these people to clearly read the vision corrected screen images without their eyeglasses.

For people who suffer from both myopia and age-related presbyopia caused by hardening of the eye lenses. Their eye muscles are weaker and it can be more difficult for older adults to change focus or adjust to fast-changing brightness. These people may need to rely on varifocal eyeglasses to improve their near and far visions in their daily lives. Some of these people may work in environments that require safety goggles to be worn, such as in the manufacturing sector. Safety goggles are more comfortable to wear without existing eyeglasses, but when they want to look at display screens 100 of their electronic devices without vision correction by the method 400, they would not be able to see the screen images clearly as they are not wearing their prescription eyeglasses. To mitigate this, some people resort to wearing the safety goggles over their existing prescription eyeglasses for good vision in their work environments as well as when looking at the display screens 100. However, this is not safe for them as the safety goggles are not positioned correctly to protect them, or in some cases not sealed properly to the face. The safest option is to customize the safety goggles according to the eye prescription, but this can be expensive. Moreover, prescription safety goggles may need to be changed every few years due to changes in eye prescription, and this adds to the costs. The method 400 can address these problems and enable these people to clearly see vision corrected screen images without their prescription eyeglasses while wearing normal safety goggles.

For deskbound work environments, wearing varifocal eyeglasses has some disadvantages, such as neck strain when viewing display screens 100 of computer monitors and limited field of view for different distances, which can result in difficulty in finding the optimum sweet spot for viewing or finding the correct angle for reading. This can cause discomfort, a fall in productivity, and possibly other longer-term physical problems. The method 400 seeks to mitigate these problems by providing vision correction to improve mobility and comfort, and hence productivity.

Drivers with hyperopia or presbyopia can have good vision on the road without eyeglasses, and the method 400 can help them to read information on the display screens 100 of their electronic devices, which are in their near vision, clearly without having to put on their prescription eyeglasses. These drivers can thus navigate their electronic devices, such as for GPS, and watch the road without discomfort of wearing or even finding their eyeglasses. Private hire or taxi drivers can see naturally on their mobile devices every time they receive a notification, while maintaining good vision on the road. The method 400 for vision correction thus enables them to interact more effectively with their mobile devices and improve productivity without compromising on road safety.

In the foregoing detailed description, embodiments of the present disclosure in relation to a computerized method and an electronic device for displaying vision corrected screen images are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computerized method for displaying vision corrected screen images on a display screen of an electronic device for a user viewing the display screen, the computerized method comprising:
receiving a set of pixel parameters of the display screen;
receiving a set of lens parameters of a lens screen of the electronic device, the lens screen comprising an array of microlenses disposed in front of the display screen;
receiving a set of eye parameters of an eye prescription for an eye of the user;
tracking the user's eye using an imaging device of the electronic device;
constructing a projection matrix based on the pixel parameters, lens parameters, and eye parameters, the construction comprising tracing light rays from each pixel of the display screen, through the microlenses that manipulate propagation of the light rays, to a retina of the user's eye;
generating an expected retina image that is expected to be focused on the retina of the user without the eye prescription;
generating a target retina image for projection on the retina, based on the projection matrix and an input screen image for displaying on the display screen;
iteratively adjusting the input screen image to determine an optimized screen image that minimizes an error between the corresponding target retina image and the expected retina image; and
displaying the optimized screen image on the display screen, wherein the optimized screen image is vision corrected for the user to view without the eye prescription.

2. The computerized method according to claim 1, wherein each pixel is divided into a plurality of sub-regions and the construction of the projection matrix comprises tracing light rays from each sub-region through the microlenses to the retina.

3. The computerized method according to claim 1, wherein the construction of the projection matrix comprises numerical interpolation of the light rays that partially pass through the user's eye.

4. The computerized method according to claim 1, wherein the construction of the projection matrix comprises calculating approximate solutions to Maxwell's equations for light propagation to simplify the projection matrix.

5. The computerized method according to claim 1, wherein the pixel parameters comprise at least one of pixel pitch between the pixels, dimensions of the pixels, arrangement of sub-regions divided from the pixels, and dimensions of the sub-regions.

6. The computerized method according to claim 1, wherein the lens parameters comprise at least one of lens pitch between the microlenses, dimensions of the microlenses, and imaging properties of the microlenses.

7. The computerized method according to claim 1, wherein the eye parameters comprise at least one of degree of myopia, degree of hyperopia, degree of presbyopia, and degree of astigmatism, and angle of astigmatism.

8. The computerized method according to claim 1, further comprising modifying the projection matrix based on positional variations of the user's eye being tracked by the imaging device.

9. An electronic device for displaying vision corrected screen images, the electronic device comprising:
a display screen for displaying the vision corrected screen images for a user viewing the display screen;
a lens screen comprising an array of microlenses disposed in front of the display screen;
an imaging device for tracking an eye of the user; and
a processor configured for:
receiving a set of pixel parameters of the display screen;
receiving a set of lens parameters of the lens screen;
receiving a set of eye parameters of an eye prescription for an eye of the user;
tracking the user's eye using the imaging device;
constructing a projection matrix based on the pixel parameters, lens parameters, and eye parameters, the construction comprising tracing light rays from each pixel of the display screen, through the microlenses that manipulate propagation of the light rays, to a retina of the user's eye;
generating an expected retina image that is expected to be focused on the retina of the user without the eye prescription;
generating a target retina image for projection on the retina, based on the projection matrix and an input screen image for displaying on the display screen;
iteratively adjusting the input screen image to determine an optimized screen image that minimizes an error between the corresponding target retina image and the expected retina image; and
displaying the optimized screen image on the display screen, wherein the optimized screen image is vision corrected for the user to view without the eye prescription.

10. The electronic device according to claim 9, wherein each microlens comprises:
a relay lens for receiving light from the display screen;
a field lens for collimating the light from the relay lens; and
the objective lens for receiving the collimated light from the field lens and directing the collimated light to the user's eye.

11. The electronic device according to claim 9, wherein each pixel is divided into a plurality of sub-regions and the construction of the projection matrix comprises tracing light rays from each sub-region through the microlenses to the retina.

12. The electronic device according to claim 9, wherein the construction of the projection matrix comprises numerical interpolation of the light rays that partially pass through the user's eye.

13. The electronic device according to claim 9, wherein the construction of the projection matrix comprises calculating approximate solutions to Maxwell's equations for light propagation to simplify the projection matrix.

14. The electronic device according to claim 9, wherein the pixel parameters comprise at least one of pixel pitch between the pixels, dimensions of the pixels, arrangement of sub-regions divided from the pixels, and dimensions of the sub-regions.

15. The electronic device according to claim 9, wherein the lens parameters comprise at least one of lens pitch between the microlenses, dimensions of the microlenses, and imaging properties of the microlenses.

16. The electronic device according to claim 9, wherein the eye parameters comprise at least one of degree of myopia, degree of hyperopia, degree of presbyopia, and degree of astigmatism, and angle of astigmatism.

17. The computerized method according to claim 9, wherein the processor is further configured for modifying the projection matrix based on positional variations of the user's eye being tracked by the imaging device.
